(19) United States
(12) Patent Application Publication
(10) Pub. No.: US 2025/0216007 A1
(43) Pub. Date: Jul. 3, 2025

(54) HYBRID TUBE FOR INDUSTRIAL AND HYDRAULIC HOSE PRODUCTS AND METHODS OF MAKING THE SAME

(71) Applicant: GATES CORPORATION, Denver, CO (US)

(72) Inventors: Morgan Morroni, Englewood, CO (US); Thomas S. Moss, III, Englewood, CO (US); Maggie Sackse, Englewood, CO (US); Sivan Zouela, Englewood, CO (US); Joseph Rein, Englewood, CO (US)

(73) Assignee: GATES CORPORATION, Denver, CO (US)

(21) Appl. No.: 18/852,595

(22) PCT Filed: Mar. 31, 2023
(86) PCT No.: PCT/US2023/017199

§ 371 Date: Sep. 30, 2024

Related U.S. Application Data
(60) Provisional application No. 63/326,034, filed on Mar. 31, 2022.

(51) Int. Cl. F16L 11/08; B29C 48/10; B29C 48/15; B29C 48/21; B29L 23/00; B32B 1/08; B32B 5/02; B32B 27/08; B32B 27/12

(52) U.S. Cl. CPC F16L 11/08; B32B 1/08; B32B 5/024; B32B 27/08; B32B 27/12; B29C 48/10; B29C 48/15; B29C 48/21; B29K 2313/00; B29L 2023/005; B32B 2250/04; B32B 2307/7376; B32B 2597/00

(57) ABSTRACT

A hybrid tube construction for use in, e.g., industrial or hydraulic hoses is described, the hybrid tube generally including coextruded interior tube and outer tube layers. The interior tube layer of the hybrid tube is a functional layer having chemical resistance to the fluid to be conveyed within the hybrid tube, while the outer tube layer is a modulus layer providing the hybrid tube with strength and flexibility. The hybrid tube may optionally include a reinforcement layer and/or cover layer. Manufacture of the hybrid tube generally uses simultaneous coextrusion of the interior tube layer material and the outer tube layer material to thereby form the hybrid tube construction. In some embodiments, the hybrid tube formed by coextrusion has sufficient structural integrity that supporting mandrels and/or post-extrusion curing steps are not required.

### TECHNICAL FIELD

The present application relates to hybrid tube constructions for use in, for example, industrial and/or hydraulic hose products. The hybrid tube includes an interior functional tube layer designed for chemical resistance to conveyed fluids and a modulus outer tube layer formed over the functional tube layer to provide the hybrid tube with flexibility and strength.

### BACKGROUND

Fluid power and fluid conveyance applications rely on tubing as an important barrier to hold in fluid and pressure. Typical tubing includes an interior tubing layer that is in contact with a fluid to be conveyed, and may further include reinforcement and/or cover layers wrapped around the interior tubing. The material of the interior tubing must not degrade with contact from the internal fluid and must be strong enough to withstand pressure and temperature. Reinforcement layers may be included to help the interior tubing withstand higher pressures.

In addition to being chemically resistant to conveyed fluid and meeting the necessary pressure and temperature demands of the fluid and tube application, there are also processing requirements that need to be met when forming the tube. For example, the interior tube must be formed in a manner that provides a hollow passage extending therethrough, but which also prevents collapse of the tube during formation. Satisfying this requirement may require selection of certain materials for the interior tubing that are strong enough to withstand collapse during, e.g., extrusion, addition of a reinforcing layer, etc., and/or use of a supporting mandrel during extrusion.

Thermoset polymeric materials are commonly used as the material for an interior tube due to their inherent flexibility, chemical resistance, and compression set. However, thermosets must be cured in their final product form (post extrusion), which requires extensive time, factory floorspace and utility costs. Additionally, uncured thermosets are easily malleable, making them prone to collapse without use of a mandrel to support the tube during processing steps before cure (such as braiding reinforcement and additional extruded layers on to the interior tube).

The use of thermoplastic materials for the interior tubing, which are rigid without curing post extrusion, remove both the need for a supporting mandrel line and autoclave curing steps. Unfortunately, the processing benefits of thermoplastic interior tubing may be offset by the diminished performance of such tubing as compared to thermoset-based tubing. For example, hoses using nylon as the interior tubing have been previously manufactured, but these hoses are stiffer than a rubber/thermoset-lined hose, and a low durometer friction layer wrapped around the interior tube is often required to achieve compression set for the coupling and to allow a braided or otherwise added reinforcement to lie down appropriately on the nylon tubing. The final hose product is also less flexible than traditional rubber and thermoset based hoses. In a different approach, polyolefin was used as the material for an interior tubing of a hose, but was not found to have good enough resistance to the conveyed fluid (e.g., oil).

Accordingly, a need exists for an improved tubing that satisfies both the performance and manufacturing requirements described previously.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a hybrid tube suitable for use in, e.g., industrial and hydraulic hoses is described, the hybrid tube including an interior tube layer having a hollow passage extending therethrough, the interior tube layer configured to have chemical resistance to a fluid conveyed through or present in the hollow passage, and an outer tube layer formed on and coaxially aligned with the interior tube layer, the outer tube layer configured to provide structure and flexibility to the hybrid tube.

In some embodiments, a method for forming a hybrid tube is described, the method including the step of coextruding an interior tube layer material and an outer tube layer material through an annular die to thereby form a hybrid tube comprising an interior tube layer having a hollow passage formed therein and an outer tube layer formed on and coaxially aligned with the interior tube layer. The method may not require use of a supporting mandrel for supporting the hybrid tube after the coextruded hybrid tube exits the annular die due to the hybrid tube as manufactured having sufficient structural integrity to ensure the hollow passage does not collapse post-extrusion. The method may also be free of any post-extrusion curing step, again due to the overall structural integrity of the hybrid tube immediately following extrusion.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a perspective view of a portion of a hybrid tube configured in accordance with various embodiments described herein.

FIG. 2 is a perspective view of a portion of a hybrid tube configured in accordance with various embodiments described herein.

FIG. 3 is a flow chart detailing a method for manufacturing a hybrid tube in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Described herein are various embodiments of hybrid tube constructions and methods for making the same, the hybrid tube being well suited for use in industrial and/or hydraulic hoses. Embodiments of the hybrid tube described herein generally include an interior tube layer that defines a hollow passage extending through the length of the tube, and an outer tube layer formed on the interior tube layer and coaxially aligned with the interior tube layer. The interior tube layer is designed to serve as a functional layer that is chemically resistant to fluids that may be conveyed through the hollow passage of the hybrid tube. The outer tube layer is designed to serve as a modulus layer that provides the hybrid tube with strength and flexibility. The combination of these two layers generally provides for a hybrid tube that includes a chemically resistant interior tube layer material that may otherwise not be suitable for use in an industrial hose due to its lack of sufficient strength, ability to maintain a hollow passage, and high cost. Furthermore, the outer tube layer material provides the hybrid tube with strength and flexibility and which, due to the use of a chemically resistant interior tube layer, can be selected from materials that might not be sufficiently chemically resistant to conveyed fluid. The strength provided to the hybrid tube through use of the outer tube layer can provide multiple benefits, including but not limited to elimination of the need for a supporting mandrel as part of the hybrid tube manufacturing process, elimination of a curing step as part of the hybrid tube manufacturing process, and/or reduction in the amount of reinforcement layer needed, including up to eliminating the need for a reinforcement layer.

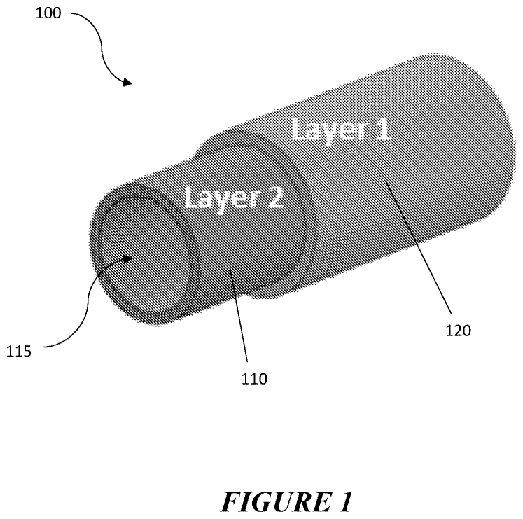

With reference to FIG. 1, a hybrid tube 100 configured in accordance with various embodiments described herein is illustrated as including an interior tube layer 110 and an outer tube layer 120 formed on the interior tube layer 110 and aligned coaxially with the interior tube layer 110. The interior tube layer 110 defines a hollow passage 115 that extends through the interior tube layer and provides a passage for fluid to be conveyed through the hybrid tube 100. The specific dimensions of the overall hybrid tube 100, the interior tube layer 110 and the outer tube layer 120 are generally not limited, though in some embodiments, the outer diameter of the interior tube layer 110 should be approximately equal to the interior diameter of the outer tube layer 120 so that the outer tube layer 120 reside directly on the interior tube layer 110.

In some embodiments, the thickness of the interior tube layer 110 is from 1 to 99% of the total thickness of the hybrid tube 100 (including additional optional layers discussed in greater detail below), such as from about 5 to about 50% of the total hybrid tube 100 thickness. In some embodiments, the thickness of the interior tube layer 110 is relatively small, such as around 10% of the overall thickness of the hybrid tube 100. The relatively thin interior tube layer 110 is capable of providing the desired chemical resistance but while minimizing the amount of interior tube layer 110 material used in the hybrid tube 100, which can thereby reduce the cost of the hybrid tube 100 (such as in instances where the cost of the interior tube layer 110 material is relatively high as compared to other materials used in the hybrid tube 100).

In some embodiments, the thickness of the outer tube layer 120 is from 1 to 99% of the total thickness of the hybrid tube 100 (including additional optional layers discussed in greater detail below), such as from about 50 to about 99%. In some embodiments, the thickness of the outer tube layer 120 is greater than the thickness of the interior tube layer 110. Along with the specific material selected for the outer tube layer 120, the thickness selected for the outer tube layer 120 may also be used to ensure the outer tube layer 120 provides the hybrid tube 100 with the desired amount of strength and flexibility. In some embodiments, the thickness of the outer tube layer 120 is designed to ensure the hybrid tube 100 passes minimum bend radius requirements for the hose product, while also being stiff enough that hybrid tube 100 does not require the use of a supporting mandrel for processing and can withstand pressures that may be experienced upon application of the hose product.

As described previously, a primary function of the interior tube layer 110 is to provide chemical resistance against fluid conveyed within the hybrid tube 100. As such, the material of the interior tube layer 110 should generally be a material that possesses the desired chemical resistance. For example, the material of the interior tube layer 110 may be selected in order to meet ASTM D543 chemical resistance testing standards, though other chemical resistance testing standards may be used in selecting the material of the interior tube layer 110. In some embodiments, the material of the interior tube layer 110 is selected from a thermoplastic, a thermoset, a ceramic, a metal, and carbon. In more specific embodiments, the material of the interior tube layer 110 is selected from a polyamide, high density polyethylene (HDPE), cross-linked HDPE, cross-linked low density polyethylene (LDPE), an ethylene propylene diene terpolymer (EPDM)/polypropylene (PP) blend, polyethylene terephthalate (PET), polyvinylidene fluoride (PVDF), and fluorinated ethylene propylene (FEP). Each of these materials can provide at least adequate chemical resistance as may be required for the specific application of the hybrid tube 100.

A primary function of the outer tube layer 120 is to provide strength and flexibility to the hybrid tube 100. As such, the material of the outer tube layer 120 should generally be a material that possesses the desired strength and flexibility. In some embodiments, the material of the outer tube layer 120 is selected from a thermoplastic, a thermoset, a ceramic, a metal, and carbon. In more specific embodiments, the material of the outer tube layer 120 is selected from a polyamide, high density polyethylene (HDPE), cross-linked HDPE, low density polyethylene (LDPE), polypropylene (homo-polymer or co-polymer), polyethylene terephthalate (PET), and polyvinylidene fluoride (PVDF). Each of these materials can provide the hybrid tube 100 with the desired combination of strength and flexibility.

Any suitable combination of interior tube layer material and outer tube layer material can be used, provided that the hybrid tube provides the desired combination of chemical resistance, improved strength, and flexibility. In some embodiments, the interior tube layer material is Nylon 12 while the outer tube layer material may be a blend of one or more polyethylene varieties (e.g., HDPE, LDPE, LLDPE, etc.) with an adhesion agent (e.g., EVA, EEA, or grafted polyethylene, etc.). In other embodiments, the interior tube layer material may be a polypropylene functional layer and the outer tube layer may be an EPDM/PP blend.

As described previously, the dimensions of the interior tube layer 110 and the outer tube layer 120 may be selected such that the outer tube layer 120 resides directly on/against the interior tube layer 110. In some embodiments, the outer tube layer 120 adheres to the interior tube layer 110 to provide for a structurally robust and cohesive hybrid tube. Any type of adhesion can be used for the interior tube layer 110 and outer tube layer 120, including multiple types of adhesion. In some embodiments, the outer tube layer 120 is adhered to the interior tube layer 110 via one or more of chemical bonding, intermolecular attraction, and mechanical adhesion. As described in greater detail below, the specific manner of adhesion may be due to the coextrusion processing used in the formation of hybrid tube 100.

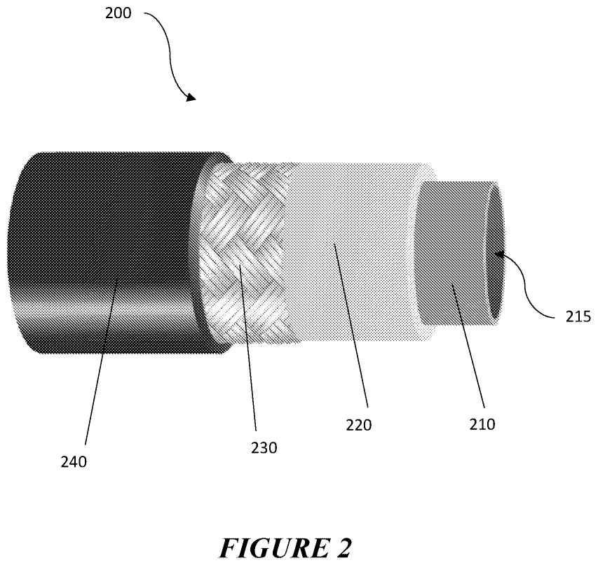

With reference now to FIG. 2, another embodiment of the hybrid tube 200 is shown wherein the hybrid tube 200 further includes an optional reinforcement layer 230 and/or an optional cover layer 240. Interior tube layer 210 and outer tube layer 220 are similar or identical to interior tube layer 110 and outer tube layer 120, respectively, described previously with respect to FIG. 1. FIG. 2 shows an additional reinforcement layer 230 formed on and coaxially aligned with the outer tube layer 220. The reinforcement layer 230 is generally included to provide additional strength and/or structural integrity to the hybrid 200, and as such, may not be required in embodiments where outer tube layer 220 provides sufficient strength and structural integrity to hybrid tube 200. In some embodiments where a reinforcement layer 230 is used, the thickness and/or amount of reinforcement layer 230 is reduced as compared to previously known tubes for industrial and/or hydraulic hoses due to increased strength provided by the outer tube layer 220, which can thereby provide reductions in costs and increased ease in manufacturing.

The specific material of the reinforcement layer 230 is generally not limited provided the material of the reinforcement layer 230 provides some amount of added strength to the hybrid tube 200. In some embodiments, the material of the reinforcement layer 230 is selected from textiles, wire, ceramic or carbon material. The reinforcement layer can be formed on the outer layer tube 220 using any suitable techniques, including, but not limited to, applying the reinforcement layer 230 in a braided, spiral wrapped or linear pattern. The material of the reinforcement layer 230 can be provided in the form of, for example, cords, filaments, yarns, wires, or mesh.

FIG. 2 further illustrates the hybrid tube 200 including a cover layer 240. While FIG. 2 shows cover layer 240 formed directly on reinforcement layer 230, it should be appreciated that in embodiments where the hybrid tube 200 does not include a reinforcement layer 230, the cover layer can be formed directly on the outer layer 220. The material of the cover layer 240 is generally selected based on the environmental conditions in which the hybrid tube 200 will be used. In some embodiments, the material of the cover layer 240 is selected from an elastomer or thermoplastic material. Another suitable material for the cover layer 240 is a thermoplastic vulcanizate (TPV) (a thermal processable material with elastomeric properties).

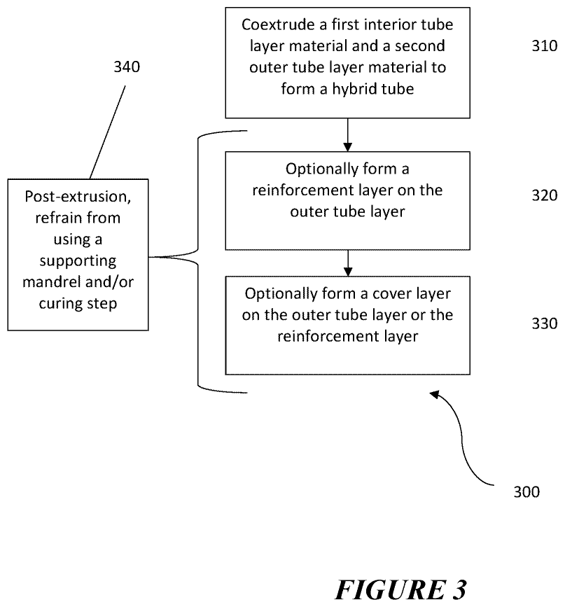

The hybrid tube 100, 200 described previously is generally manufactured using coextrusion processing. With reference to FIG. 3, a method 300 for manufacturing a hybrid tube as described herein is shown, the method 300 generally including a step 310 of coextruding an interior tube layer material and an outer tube layer to thereby form the hybrid tube structure described previously and as shown in FIG. 1. Generally speaking, the coextrusion step 310 generally includes the use of a coextruder equipped with an annular die such that flowable interior tube material and flowable outer tube material is combined in a layered fashion (outer tube layer material layered on top of interior tube layer material) proximate the annular die, at which point the combined material is extruded through the annular die to at least partially harden the materials and form the hybrid tube construction.

Because the coextruded layers are laid down as molten or tacky layers, material layers with different thickness, modulus, and/or melt temperature (e.g., within 50° C.) can be used with minimal or no compatibility issues. The layers of the coextruded hybrid tube will be adhered through chemical bonding, intermolecular attraction, and/or mechanical adhesion as a result of being extruded under pressure. The adhesion between the interior tube layer and the outer tube layer is preferably designed to be at least the minimum required to hold the layers together during the application of the hybrid tube in use by itself or with braided reinforcement and/or cover layers. If a reinforcement layer is used, the adhesion between the outer tube layer and the reinforcement should also be greater than the minimum required for the application.

FIG. 3 shows optional additional steps for adding a reinforcement layer (step 320) and/or cover layer (330) to the hybrid tube. The reinforcement layer and cover layer can be similar or identical to the reinforcement layer and cover layer described previously with respect to FIG. 2, and can be formed on the hybrid tube using any previously known techniques. Step 330 of forming a cover layer can be include forming a cover layer on a reinforcement layer or on an outer tube layer in embodiments where a reinforcement layer is not used.

Step 340 of FIG. 3 emphasizes that by virtue of the materials used for the interior tube layer and the outer tube layer, as well as the coextrusion step of 310, the method 300 may be free of a supporting mandrel and/or curing step post-extrusion step 340. In some previously known process, the structural integrity of the extruded tube is sufficiently weak that the hollow passage of the tube will collapse unless the tube is extruded onto a supporting mandrel. The supporting mandrel typically has a diameter approximately equal to the diameter of the tube's hollow passage such that the supporting mandrel extends through the hollow passage when the extruded tube exits the die and passes on to the supporting mandrel. Need for a supporting mandrel will typically increase the manufacturing footprint, which can reduce manufacturing capacity and production sites. In embodiments of the method 300 described herein, the hybrid tube extruded in step 310 has sufficient structural integrity that the hollow passage is maintained without need for a supporting mandrel.

Similarly, step 340 emphasizes that method 300 can be performed without need for any post-extrusion curing steps. This may be due to the materials that can be used for the interior tube layer and outer tube layer, and the coextrusion process used to produce the hybrid tube construction. In such embodiments, the hybrid tube that exits the extruder has sufficient strength that curing in, for example, and autoclave, is not required.

The hybrid tube described herein, including the methods for manufacturing hybrid tube described herein, can provide a variety of advantages. For example, the hybrid tube construction allows for a vast array of material combinations to produce hybrid tube that meets various application requirements. In some embodiments, the technology described herein allows for the use of chemically resistance materials (for the interior tube layer) which could not otherwise be used because of undesirable physical properties or their cost prohibitive nature. Furthermore, outer tube layer materials can be made stiff enough (while still possessing a high enough flexural modulus) that use of a supporting mandrel for processing is not required, and so that hybrid tube can withstand higher pressures with less or no reinforcement layer material. Without the need to focus on chemical resistance (which will be handled by the interior tube layer), the outer tube layer can be very specifically designed to provide the desired flexural modulus. This allows for hybrid tubes that are flexible enough to allow the tube to pass minimum bend radius requirements for the product. Due to the improved structural strength exhibited by the hybrid tube described herein, the hybrid tube can be made with materials which do not require a supporting mandrel or curing in an autoclave post-extrusion. As a result, the manufacturing process possesses a smaller equipment footprint, which will allow for more capacity at production sites.

Hybrid tubes as described herein may have potential applications in industrial, food and beverage, hydraulic, chemical caustics, pneumatics, automotive, aerospace, and other fluid conveyance, or fluid power applications. In some embodiments, the hybrid tubes described herein satisfy the specifications set for SAE100R7 and SAE100R8 hydraulic thermoplastic hoses. The hybrid tubes can be formulated to carry a variety of materials including water, steam, caustic fluids, acidic fluids, solvents, flammable fluids, air, gases, and oil. While the present disclosure generally discusses conveyed fluids, embodiments of the hybrid tube described herein are suitable for use with any internal fluids, whether conveyed through the tube or generally retained within the tube.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A hybrid tube for use in industrial and hydraulic hoses, comprising:
an interior tube layer having a hollow passage extending therethrough, the interior tube layer configured to have chemical resistance to a fluid conveyed through or present in the hollow passage; and
an outer tube layer formed on and coaxially aligned with the interior tube layer, the outer tube layer configured to provide structure and flexibility to the hybrid tube.

2. The hybrid tube of claim 1, wherein the thickness of the outer tube layer is greater than the thickness of the interior tube layer.

3. The hybrid tube of claim 1, wherein the interior tube layer is from about 5 to about 50% of the thickness of the hybrid tube and the outer tube layer is from about 50 to about 95% of the thickness of the hybrid tube.

4. The hybrid tube of claim 1, wherein the interior tube layer is about 10% of the thickness of the hybrid tube.

5. The hybrid tube of claim 1, wherein the material of the interior tube layer is selected from the group consisting of a thermoplastic, a thermoset, a ceramic, a metal, and carbon.

6. The hybrid tube of claim 1, wherein the material of the outer tube layer is selected from the group consisting of a thermoplastic, a thermoset, a ceramic, a metal, and carbon.

7. The hybrid tube of claim 1, wherein the material of the interior tube layer is selected from the group consisting of a polyamide, high density polyethylene (HDPE), cross-linked HDPE, cross-linked low density polyethylene (LDPE), an ethylene propylene diene terpolymer (EPDM)/polypropylene (PP) blend, polyethylene terephthalate (PET), polyvinylidene fluoride (PVDF), and fluorinated ethylene propylene (FEP).

8. The hybrid tube of claim 1, wherein the material of the outer tube layer is selected from the group consisting of a polyamide, high density polyethylene (HDPE), cross-linked HDPE, low density polyethylene (LDPE), polypropylene, polyethylene terephthalate (PET), and polyvinylidene fluoride (PVDF).

9. The hybrid tube of claim 1, wherein the interior tube layer is adhered to the outer tube layer via one or more of chemical bonding, intermolecular attraction, and mechanical adhesion.

10. The hybrid tube of claim 1, further comprising:
a reinforcement layer formed on and coaxially aligned with the outer tube layer.

11. The hybrid tube of claim 10, wherein the reinforcement layer is applied to the outer tube layer in a braided, spiral wrapped or linear pattern.

12. The hybrid tube of claim 10, wherein the material of the reinforcement layer is selected from the group consisting of textiles, wire, ceramic or carbon material.

13. The hybrid tube of claim 10, further comprising:
a cover layer formed on and coaxially aligned with the reinforcement layer.

14. The hybrid tube of claim 10, wherein the material of the cover layer is selected from the group consisting of an elastomer or thermoplastic.

15. The hybrid tube of claim 1, further comprising:
a cover layer formed on and coaxially aligned with the outer tube layer.

16. The hybrid tube of claim 15, wherein the material of the cover layer is selected from the group consisting of an elastomer or thermoplastic.

17. The hybrid tube layer of claim 1, wherein the hybrid tube is free of a reinforcement layer.

18. A method for forming a hybrid tube, comprising:
coextruding an interior tube layer material and an outer tube layer material through an annular die to thereby form a hybrid tube comprising an interior tube layer having a hollow passage formed therein and an outer tube layer formed on and coaxially aligned with the interior tube layer.

19. The method of claim 18 wherein the interior tube layer material is selected from the group consisting of a polyamide, high density polyethylene (HDPE), cross-linked HDPE, cross-linked low density polyethylene (LDPE), an ethylene propylene diene terpolymer (EPDM)/polypropylene (PP) blend, polyethylene terephthalate (PET), polyvinylidene fluoride (PVDF), and fluorinated ethylene propylene (FEP).

20. The method of claim 18, wherein the outer tube layer material is selected from the group consisting of a polyamide, high density polyethylene (HDPE), cross-linked HDPE, low density polyethylene (LDPE), polypropylene, polyethylene terephthalate (PET), and polyvinylidene fluoride (PVDF).

21. The method of claim 18, wherein the coextruded hybrid tube is transferred on to a supporting mandrel after being extruded through the annular die, the supporting mandrel extending through the hollow passage of the hybrid tube.

22. The method of claim 18, wherein the coextruded hybrid tube passes out of the annular die freely and without support from a support mandrel.

23. The method of claim 18, wherein the coextruded hybrid tube exiting the annular die has sufficient structural integrity such that the hollow passage does not collapse after exiting the annular die.

24. The method of claim 18, wherein the method is free of any curing steps after coextrusion of the interior tube layer material and the outer tube layer material through the annular die.

25. The method of claim 18, further comprising:
adding a reinforcement layer to the coextruded hybrid tube, the reinforcement layer formed on the outer tube layer and being coaxially aligned with the interior tube layer and the outer tube layer.

26. The method of claim 25, wherein the material of the reinforcement layer is selected from the group consisting of textiles, wire, ceramic or carbon material.

27. The method of claim 25, further comprising:
adding a cover layer to the hybrid tube, the cover layer formed on the reinforcement layer and being coaxially aligned with the interior tube layer, the outer tube layer and the reinforcement layer.

28. The method of claim 27, wherein the material of the cover layer is selected from the group consisting of an elastomer or thermoplastic.

29. The method of claim 18, further comprising:
adding a cover layer to the hybrid tube, the cover layer formed on the outer tube layer and being coaxially aligned with the interior tube layer and the outer tube layer.

30. The method of claim 29, wherein the material of the cover layer is selected from the group consisting of an elastomer or thermoplastic.
